(19) United States
(12) Patent Application Publication
(10) Pub. No.: US 2006/0111939 A1
(43) Pub. Date: May 25, 2006

(54) Apparatus and method for making hospital staff assignments

(76) Inventors: Craig S. Bixler, Saint Charles, IL (US); Mohmet Unluturk, Yesilyurt/Izmir (TR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/142,344

(22) Filed: Jun. 2, 2005

Related U.S. Application Data
(60) Provisional application No. 60/575,817, filed on Jun. 2, 2004.

(51) Int. Cl. G06Q 10/00; G06Q 50/00

(52) U.S. Cl. 705/2

(57) ABSTRACT

An apparatus and method for receiving data, organizing the data, and constructing hospital staff assignments based on the data. Where hospital staff assignments are instructions that designate which hospital staff members are responsible for which hospital beds. An embodiment in accordance with the present invention provides a data source, a managing device, a messaging device, and a network linking the aforementioned devices. In operation, the data source updates the managing device when data is newly added or modified, and the managing device organizes and provides relevant data to an assignment device. Based on the relevant data, the assignment device constructs efficient staff assignments.

### CROSS-REFERENCE TO RELATED APPLICATIONS

This application claims priority to U.S. provisional patent application entitled, HOSPITAL STAFF ASSIGNMENTS WITH PATIENT INFORMATION, filed Jun. 2, 2004, having a Ser. No. 60/575,817, the disclosure of which is hereby incorporated by reference in its entirety.

### FIELD OF THE INVENTION

The present invention relates generally to the field of communication networks. More particularly, the present invention relates to an apparatus and method for receiving data, organizing the data, and constructing hospital staff assignments based on the data.

### BACKGROUND OF THE INVENTION

Hospital staff assignments allocate hospital staff members to hospital beds. Currently, many hospital administrators create staff assignments without access to information regarding the occupancy of the hospital beds and the acuity of the patient located in each of the hospital beds. Bed occupancy information indicates the bed numbers that are occupied by a patient. Patient acuity indicates the severity of the patient's condition.

Bed occupancy and patient acuity information is important because bed occupancy and patient acuity directly correspond to the amount of staff time required to properly care for each patient. For example, an unoccupied bed requires no staff time and a bed occupied by a patient having a high acuity level requires a substantial amount of time. However, when constructing staff assignments without access to bed occupancy and patient acuity level information, the administrator is unable to distinguish between occupied and unoccupied beds and therefore assigns staff to unoccupied beds. This results in creating uneven and inefficient staff assignments.

Further, assigning an equal number of occupied beds to each staff member may not create an efficient staff assignment because patient acuity levels among the assigned beds may vary and thus the necessary amount of staff time will vary among the assigned beds. For example, a particular nursing unit may consist of ten occupied beds. Three beds are occupied by patients having high acuity levels, three bed are occupied by patients having medium acuity levels, and four beds are occupied by patients having low acuity levels. Assigning an equal number of beds to each staff member without considering the acuity level of the patient within each bed may not evenly distribute the workload. If patient acuity levels are not considered, a staff member may be assigned to two beds having high acuity level patients and three beds having medium acuity level patients whereas another staff member may only be assigned to one bed having a high acuity patient and four beds having low acuity patients. Despite assigning an equal number of beds to each staff member, this staff assignment will create an uneven workload among the two staff members.

However, if patient acuity levels are considered when constructing staff assignments, the administrator can evenly distribute the workload among the staff members. In the aforementioned example, the administrator may assign the first staff member two beds having high acuity level patients, one bed having a medium acuity level patient, and one bed having a low acuity patient and assign the other staff member one bed having a high acuity level patient, two beds having medium acuity level patients, and three beds having low acuity level patients. Despite assigning an unequal number of beds to each staff member, this staff assignment will create an evenly distributed workload among the staff members.

Accordingly, it is desirable to provide an apparatus and method that integrates an hospital staff assignment device and a database that contains bed occupancy and patient acuity information thereby enabling an individual such as an administrator to consider bed occupancy and patient acuity data when making staff assignments. Such an apparatus and method will enable administrators to created more efficient staff assignments in less time.

### SUMMARY OF THE INVENTION

The foregoing needs are met, to a great extent, by the present invention, wherein in one aspect an apparatus and method are provided that in some embodiments integrates a hospital census database with an hospital staff assignment device and, thereby, enables administrators to consider bed occupancy and patient acuity when making staff assignments. Thus, enabling administrators to created more efficient staff assignments in less time.

In accordance with one embodiment of the present invention is an apparatus linked to a network and configured to create hospital staff assignments, comprising a system image table device linked to a data source configured to organize and store data received from the data source and an assignment device linked to the system image table device configured to enable the data to be assigned.

In accordance with another aspect of the present invention is method for assigning hospital staff members to hospital bed numbers, comprising: receiving data from a data source; organizing data in a system image table device; and creating an assignment for the data with an assignment device.

In accordance with yet another embodiment of the present invention is an apparatus linked to a network and configured to create hospital staff assignments, comprising a system image table device linked to a data source configured to organize and store bed occupancy data and patient acuity level data received from the data source and an assignment device linked to the system image table device configured to enable the data to be assigned.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram illustrating a communication network according to the preferred embodiment of the present invention.

FIG. 2 is a block diagram of an apparatus for receiving data, organizing the data, and constructing hospital staff assignments based on the data.

FIG. 3 is a flowchart outlining an operation for a system for receiving data, organizing the data, and constructing hospital staff assignments based on the data.

### DETAILED DESCRIPTION

The invention will now be described with reference to the drawing figures, in which like reference numerals refer to like parts throughout. The present invention provides an apparatus and method for receiving data, organizing the data, and constructing hospital staff assignments based on the data. Where hospital staff assignments include instructions that designate which hospital staff members are responsible for which hospital beds. An embodiment in accordance with the present invention provides a data source, a managing device, a messaging device, and a network linking the aforementioned devices. In operation, the data source updates the managing device when data is newly added or modified, and the managing device organizes and provides relevant data to an assignment device. Based on the relevant data, the assignment device constructs efficient staff assignments.

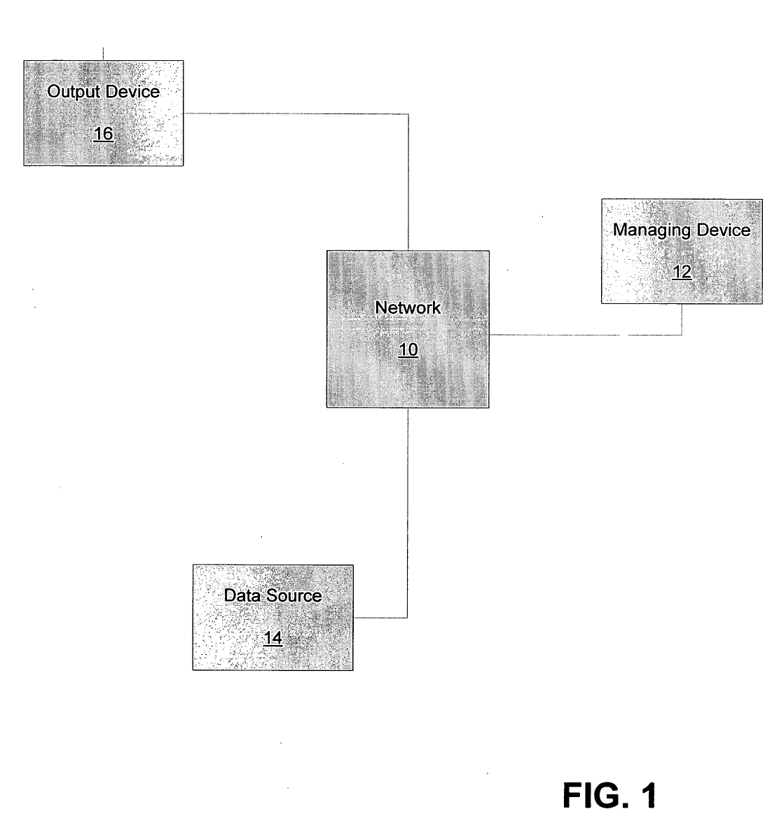

FIG. 1 is an exemplary communication network 10 according to the disclosed apparatus and method. As shown in FIG. 1, the exemplary network 10 includes a managing device 12, a messaging device 16 and a data source 14. It should be appreciated that the above mentioned components 12-16 can be linked together by any architecture that is well known to those of ordinary skill in the art.

The communication network 10 facilitates, for example, the transmission of patient, bed, and staff information to hospital administrators. For example, the managing device 12 organizes and stores up-to-date data obtained from the data source 14. Based on the data, the managing device 12 constructs, for example, a table comprising occupied beds, unoccupied beds, patient names, patient acuity levels, staff member names, and messaging device numbers.

The data source 14 is, for example, an admit discharge transfer system (hereinafter referred to as “ADT”). The ADT maintains a census for the hospital, for example, the name, bed number, and acuity level of each admitted patient.

The ADT is in communication with the managing device 12 via an industry standard HL7 protocol. For example, when a patient is admitted to the hospital, the ADT will communicate the newly admitted patient's information to the managing device 12. The managing device 12 can locally store and organize the new patient's information and construct staff assignments based thereon.

It should also be appreciated that the data source 14 is, for example, a nurse call device in communication with the managing device 12. The nurse call device provides updated data regarding bed lists and associated bed groups, typically a nursing unit. The nurse call device can also update the managing device 12 regarding the status or condition of the patient.

The messaging device 16 can take many different forms and be utilized in many different locations. For example, the messaging device 16 can be a pager, cell phone, intercom system display, or a display monitor. The data source 14 contains the necessary information to transmit a signal to the messaging device 16, such as device telephone numbers or internet protocol addresses. Also, the data source 14 contains a log of the particular messaging devices 16 that are assigned to each staff member such that, when necessary, a message can be sent to any given staff member. The data source 14 transmits the messaging device 16 information to the managing device 12, which presents the messaging device 16 information to users along with information such as occupied beds, unoccupied beds, patient names, patient acuity levels, staff member names.

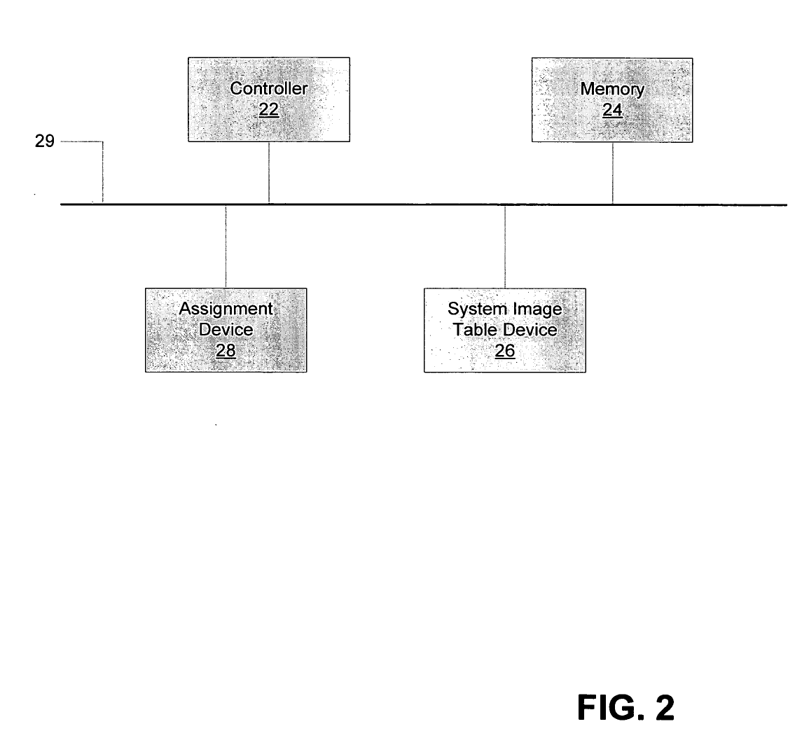

Referring now to FIG. 2, the managing device 12 includes, for example, a controller 22, a memory 24, a system image table device 26, and an assignment device 28. The above mentioned components can be coupled by a control/data bus 29. Although, it should be appreciated that any other architecture, as known to those of ordinary skill in the art, may be used to couple the above mention components. It should also be appreciated that system image table device 26 and the assignment device 28 can take the form of a software/firmware routine residing in memory 24 capable of being executed by the controller 22.

The system image table device 26 stores and organizes the information obtained by the managing device 12 pursuant to its communication with the data source 14. Thus, when utilized in a hospital, the system image table device 26 contains up-to-date information relating to each admitted patient, each bed located with in the hospital, and each staff member. The system image table device 26 organizes the information obtained from the data source 14 by categorizing the data into information fields. These information fields may include the patient name, patient acuity, occupied bed numbers, unoccupied bed numbers, staff member names, messaging device 16 routing information, and current staff assignments. Where the current staff assignment information is information such as the doctor, nurse, staff member, or team that is currently responsible for each occupied bed. It should be appreciated that data may be manually inputted into the system image table device 26.

The assignment device 28 is capable of obtaining all patient, bed, messaging device 16, and staff information from the system image table device 26. For example, hospitals are often categorized by nursing units such as an intensive care unit or pediatric unit. An administrator representing a particular nursing unit can utilize the assignment device 28 to access the system image table device 26 and, thus, obtain all patient, bed, and staff information relating to his/her nursing unit. The information provided to the assignment device 28, for example, includes a list of all occupied beds in the nursing unit, all unoccupied beds in the nursing unit, the patient name associated with each occupied bed, the on-duty staff members, and the routing information for the messaging device 16 associated with each staff member.

The assignment device 28 is a display output and a browser or resident application input that receives information from the system image table device 26. However, it should be appreciated that the assignment device 28 can receive information from other sources, such as, the data source 14 and sources not linked to the network 10. The assignment device 28 displays patient names, patient acuity levels, occupied bed numbers, unoccupied bed numbers, staff member names, messaging device 16 routing information, and the current staff assignments to the operator and enables an operator to assign or reassign a staff member to each occupied bed.

The assignment device 28 is capable of suggesting staff assignments. For example, the assignment device 28 designates a numerical value that represents the acuity level of each patient. The numerical value designated to each patient indicates the approximate amount of staff time necessary to properly care for the patient. For example, the higher the patient acuity level, the higher the numerical value assigned, and the higher the amount of necessary staff time. Based on the numerical values that represent the patient acuity levels, the assignment device 28 calculates how to best distribute the workload evenly among the staff. For example, the assignment device 28 aggregates the patient acuity level numerical values within a specific nurse unit and approximately assigns an equal patient acuity level numerical value to each staff member.

The assignment device 28 also presents, to the user, a grid comprising a bed number column, a patient name column, a patient acuity level column, a staff member name column, and a messaging device 16 routing information column. The assignment device 28 enables the user to sort the information via patient name. Therefore, the unoccupied bed numbers (beds not having a patient name associated therewith) are shifted to the bottom rows of the grid because rows having an unoccupied bed have a blank patient name column. Thus, the user can focus solely on the occupied beds, which saves time and decreases the likelihood that the user will inadvertently assign an unoccupied bed. Also, the assignment device 28 highlights the rows having occupied beds that are yet to be assigned. Thus, reducing the possibility that an occupied bed goes unassigned. Also to ensure that all occupied beds are assigned, the assignment device 28 provides a status warning to the user that indicates any unassigned occupied beds.

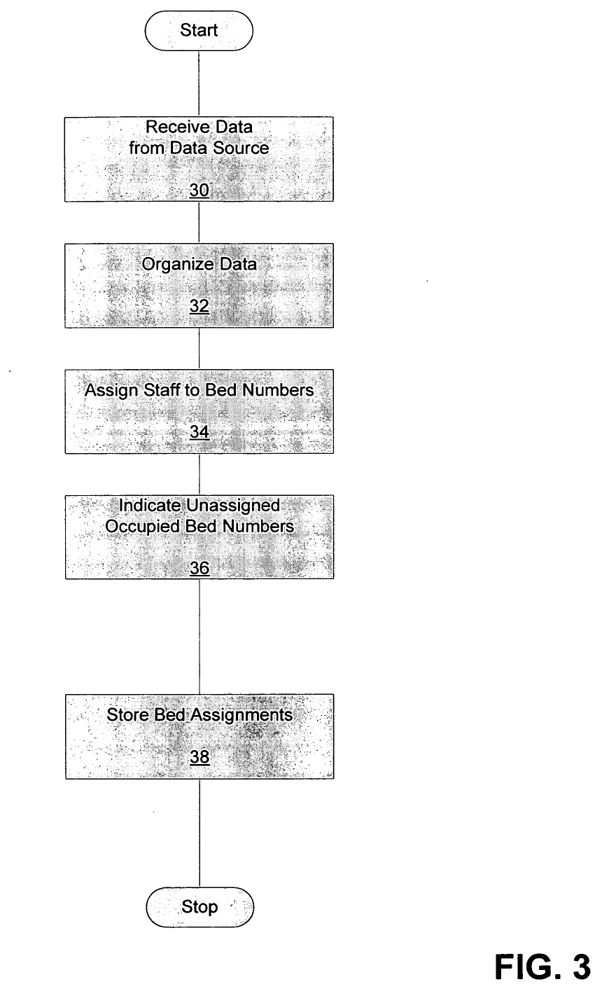

FIG. 3 is a flowchart outlining an exemplary operation according to the present disclosure for a system capable of assigning hospital staff members to hospital bed numbers. The operation starts at step 30, where the system image table device 26 receives data from the data source 14. For example, the nurse call device and the ADT transmit bed and patient data to the system image table device 26. Next, in step 32 the system image table device 26 organizes the patient and bed data. The system image table device 26 groups the data based on nursing unit to which the data pertains. Further, the system image table device 26 organizes the data by categories, such as, patient name, patient acuity level, occupied bed number, unoccupied bed number, staff member name, messaging device 16 routing information, and current staff assignments.

Next, in step 34 the system creates assignment data via the assignment device 28. The assignment data comprises the occupied bed numbers and the staff member names assigned to the occupied bed numbers. In step 36 the system indicates which, if any, occupied bed numbers are not assigned to a staff member. This ensures that all patients are assigned to a staff member. Finally, in step 38, the assignment device 28 transmits the assignment data to the system image table device 26 where it is stored an made available to other clients linked to the network 10. It should be appreciated that the assignment device 28 transmits the assignment data directly to the hospital staff members via the messaging device 16.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus linked to a network and configured to create hospital staff assignments, comprising:
a system image table device linked to a data source configured to organize and store data received from the data source; and
an assignment device linked to the system image table device configured to enable the data to be assigned.

2. The apparatus of claim 1, wherein the data received from the data source is a bed data and a patient data.

3. The apparatus of claim 2, wherein the bed data is a bed number.

4. The apparatus of claim 3, wherein the patient data is a patient name, the bed number associated with the patient name, and an acuity level associated with the patient name.

5. The apparatus of claim 4, wherein the system image table device organizes the data received from the data source by categorizing the data into a patient name category, a bed number category, and an acuity level category.

6. The apparatus of claim 3, wherein the bed data is an unoccupied bed number and an occupied bed number.

7. The apparatus of claim 2, wherein the data source is a nurse call device, and the nurse call device transmits the bed data to the system image table device.

8. The apparatus of claim 2, wherein the bed data is manually inputted into the system image tables.

9. The apparatus of claim 2, wherein the data source is a database, and the database provides the patient data to the system image table device.

10. The apparatus of claim 2, wherein the assigned data is based upon linking the bed data to a hospital staff member name.

11. The apparatus of claim 6, wherein the assignment data is the occupied bed number not combined with a hospital staff member name.

12. The apparatus of claim 6, wherein the assignment device assigns a particular acuity level capacity and an accumulated total patient acuity level to the staff member name.

13. The apparatus of claim 1, wherein the assigned data is transmitted from the assignment device to the system image table device.

14. A method for assigning hospital staff members to hospital bed numbers, comprising:
receiving data from a data source;
organizing data in a system image table device; and
creating an assignment for the data with an assignment device.

15. The method of claim 14, wherein the data received from the data source is a bed data and a patient data.

16. The method of claim 15, wherein the bed data is a bed number.

17. The method of claim 16, wherein the patient data is a patient name, the bed number associated with the patient name, and an acuity level associated with the patient name.

18. The method of claim 15, wherein the bed data is an unoccupied bed number and an occupied bed number.

19. The method of claim 14, further comprising prompting manually constructing the assignment with the assignment device based on accumulated assigned patient acuity, bed occupied status, and staff acuity capacity.

20. The method of claim 14, wherein the assignment data is the bed data linked with a hospital staff member name.

21. The method of claim 18, wherein the assignment data is the occupied bed number not combined with a hospital staff member name.

22. The method of claim 21, further comprising notifying the user of the assignment data.

23. The method of claim 18, wherein the assignment data is the unoccupied bed number.

24. An apparatus linked to a network and configured to create hospital staff assignments, comprising:
a system image table device linked to a data source configured to organize and store bed occupancy data and patient acuity level data received from the data source; and
an assignment device linked to the system image table device configured to enable the data to be assigned.
